(19) United States
(12) Patent Application Publication
(10) Pub. No.: US 2018/0174369 A1
(43) Pub. Date: Jun. 21, 2018

(54) METHOD, APPARATUS AND SYSTEM FOR TRIGGERING INTERACTIVE OPERATION WITH VIRTUAL OBJECT

(71) Applicant: Guangzhou UCWEB Computer Technology Co., Ltd., Guangzhou (CN)

(72) Inventors: Miaokui MA, Guangzhou (CN); Yongchao LAO, Guangzhou (CN)

(21) Appl. No.: 15/849,978

(22) Filed: Dec. 21, 2017

(30) Foreign Application Priority Data
Dec. 21, 2016 (CN) 201611192269.X

(51) Int. Cl. G06T 19/00; G06K 9/00; H04W 4/12; G06F 17/30

(52) U.S. Cl. CPC G06T 19/006; G06F 17/30041; H04W 4/12; G06K 9/00208

(57) ABSTRACT

Provided is a new triggering solution for interacting with a virtual object. The solution first pre-screens according to the current geographic location information of a mobile terminal the candidate object associated with the current location, and then matches the candidate object with the reproduced target on the mobile terminal, so as to provide the interactive operation with the virtual object associated with the reproduced target. In this way, terminal users can be provided with a variety of services based on geographic location, thereby enhancing user's engagement and live feeling.

### TECHNICAL FIELD

The present invention relates to the field of information technology. In particular, it related to a method, an apparatus and a system for triggering an interactive operation with a virtual object.

### BACKGROUND ART

With the increasing processing speed and rendering capabilities of mobile devices, more and more people use virtual objects (VO) displayed on mobile devices to learn, communicate or play games. Especially with the popularity of augmented reality (AR) technology, people are exposed more to various virtual objects that can interact with them. AR technology is able to enhance reality by way of superimposing computer-generated virtual objects, scenes, or system hints onto certain real scenes. FIG. 1 shows an example of triggering the display and interaction of virtual objects in the existing technology. The figure shows the display of a virtual 3D heart 102 triggered by scanning a planar heart image 101 in a real scene. The user can then perform various operations on the virtual object through the options provided in the lower right corner of the screen. Through the display and operation of virtual objects, users are able to break the boundaries of space, time, and other objective limits, and have unique experiences that do not exist in the real world.

At present, virtual objects, especially augmented reality (AR) technology in combination with real scenes, have been widely applied in the fields of teaching, navigation, information inquiry, entertainment and so on. However, the currently available virtual object interactions are usually limited to the phase of calling a limited number of 3D models or 2D images stored in a specific application, and thus lack of a wide range of application scenarios.

### SUMMARY OF INVENTION

In order to solve at least one of the above problems, the present invention proposes a completely new triggering solution for interacting with a virtual object. The solution is as follows: first pre-screens according to the current geographic location information of a mobile terminal the candidate objects associated with the current location (for example, a landmark of the current location), and then matches the candidate object with the reproduced targets on the mobile terminal, so as to provide the interactive operation (for example, an interactive service) with the virtual object associated with the reproduced target. In this way, terminal users can be provided with a variety of services based on their geographic locations, thereby enhancing the user's engagement and enjoyment.

According to one aspect of the present invention, the present invention provides a method for triggering an interactive operation with a virtual object, including: obtaining the current geographic location information of a mobile terminal; querying, in a database, candidate object information associated with the current geographic location information; obtaining reproduced image information on the mobile terminal; identifying a target object that matches the candidate object information from the reproduced image information; and triggering an interactive operation with a predetermined virtual object associated with the target object on the mobile terminal. In addition, the foregoing method is preferably implemented by a server.

According to another aspect of the present invention, the present invention provides a method for triggering an interactive operation with a virtual object on a mobile terminal, including: sending current geographic location information to a server; receiving candidate object information associated with the current geographic location information queried by the server from a database; identifying a target object that matches the candidate object information from reproduced image information; and triggering an interactive operation with a predetermined virtual object associated with the target object.

According to yet another aspect of the present invention, the matching process with the candidate object information may be performed by a server. Hence, a method for triggering an interactive operation with a virtual object on a mobile terminal, includes: sending reproduced image information and current geographic location information to a server; receiving target object matching information of a target object identified from the reproduced image information returned from the server, where the target object matches a candidate object, and candidate object information is the candidate object information associated with the current geographic location information queried by the server from a database; triggering an interactive operation with a predetermined virtual object associated with the target object according to the target object matching information.

In this way, it is able to provide a more accurate interactive operation based on a user's current location. In addition, since the number of candidate objects that need to be matched is limited, Identification for the target object can be more flexible.

Preferably, the candidate object information associated with the current geographic location information includes the candidate object information associated with a landmark object corresponding to the current geographic location information. By way of associating the candidate objects with a landmark object, candidate objects associated with the current location can be more accurately provided or identified, thereby improving the accuracy and timeliness of the solution.

Preferably, the candidate object associated with the current geographic location and the matched target object can be at least one of the following objects: a product, a business logo, or another specific graphic shape. The triggering solution of the present invention is particularly suitable for commercial applications. By way of identifying certain specific products, logos and shapes, the triggering solution of the present invention can be used to enter the interactive scenes associated with a location, so as to further enhance the business interaction experience and bring benefits to both businesses and users.

Preferably, the interactive operation of a predetermined virtual object associated with the target object provides a service associated with the target object. Thereby further optimizing the virtual object interactive operation scenarios.

Preferably, the predetermined virtual object is not directed to the identified target object itself. Different from the conventional techniques for enhancing display of the target object itself, the interaction-based virtual object in the present invention is an object related to but different from the target object, thereby further expanding the application scenario of the interactive operation.

Preferably, the interactive operation of the predetermined virtual object associated with the target object includes at least one of the followings: the virtual object performs an action associated with the target object, and the result of the interactive operation is associated with the target object. In this way, the interaction with the virtual object can be associated with the target object in many different ways, so as to further enrich the interactive scenario and enhance the user experience.

Preferably, an interactive operation between a user of mobile terminal and the virtual object may be a business, a game, and/or a social activity associated with the target object. The inventive interactive triggering solution associated with the current location and the reproduced image provided in the present invention is particularly suitable for various promotional activities having a strong dependency on their specific locations, such as business, gaming and/or social activities, and so on.

For various commercial promotions, the business, gaming, and/or social activity associated with the target object may preferably include at least one of the following: obtaining a promotion voucher associated with the target object, initiating an online transaction associated with the target object, entering a community associated with the target object; or obtaining a reward activity within a community associated with the target object. Preferably, the virtual object includes a virtual red envelope.

Preferably, the reproduced image may be a real-time image captured by a mobile terminal, and the triggering solution of the present invention may therefore be combined with an AR technique for obtaining an augmented reality operation of superimposing the predetermined virtual object onto the real-time image taken by the in the mobile terminal. The reproduced image may also be a real-time image read by the mobile terminal or an image in a video played in real time by the mobile terminal, thereby further improving the applicable flexibility of the triggering solution provided in the present invention.

Preferably, the interaction operation information of the predetermined virtual object is pre-stored in the mobile terminal or sent from the server. This allows selecting the place for virtual object storage based on the actual situation, thereby providing a flexible and timely interactive operation service.

Preferably, the acquisition of the current geographic location information and the reproduced image information may be performed in any order or simultaneously before the target object is matched, as long as the matching process between the reproduced image and the candidate object can be performed in time.

According to yet another aspect of the present invention, a sharing method is also provided, which includes: generating sharing content and at least one sharing link access according to an interaction result of the interactive operation triggered according to any one of the foregoing methods; and publishing the sharing content to the corresponding location indicated by the access selected by a user according to the user's section on the sharing link access, in which the sharing content may be a screenshot or an animation of an augmented reality operation in which the predetermined virtual object is superimposed onto the real time image captured by the mobile terminal, or may be a content that is a combination of user features (for example, a user avatar).

According to yet another aspect of the present invention, a virtual object interaction system is provided, which includes a server and a mobile terminal. The mobile terminal reproduces an image and sends the current geographic location information to the server. The server queries a database for the candidate object information corresponding to the current geographic location information, in which a target object that matches the candidate object is identified from the reproduced image by the server or the mobile terminal, so as to trigger a display of a predetermined virtual object on the mobile terminal, and the predetermined virtual object interacting with a user of the mobile terminal, where the interaction is associated with the target object.

According to yet another aspect of the present invention, an apparatus for triggering an interaction with a virtual object on a mobile terminal is provided. The apparatus includes: a geographic information sending unit, which is configured to send the current geographic location information to a server, a candidate object information receiving unit, which is configured to receive the candidate object information that is obtained by the server through querying a database and is associated with the current geographic location information; a target object identifying unit, which is configured to identify a target object matching the candidate object information from the reproduced image; and an interactive operation triggering unit, which is configured to trigger an interactive operation of a predetermined virtual object associated with the target object.

According to yet another aspect of the present invention, an apparatus for triggering an interactive operation with a virtual object on a mobile terminal is provided. The apparatus includes: an information sending unit, which is configured to send the reproduced image information and the current geographic location information to a server; a matching information obtaining unit, which is configured to receive, the target object matching information of the target object identified from the reproduced image retuned from the server, in which the target object matches the candidate object, and where the candidate object information is the candidate object information obtained through a querying by the server from a database and associated with the current geographic location information, an interactive operation triggering unit, which is configured to trigger an interactive operation of a predetermined virtual object corresponding to the target object according to the target object matching information.

According to yet another aspect of the present invention, a method for interacting with a virtual object on a mobile terminal is provided, the method includes: reproducing an image at a current geographic location; identifying a target object associated with the current geographic location from the image; displaying a virtual object associated with the target object for the interactive operation.

According to yet another aspect of the present invention, a graphical user interface system used on a portable electronic device with a touch screen display is provided, the graphical user interface system includes: an image display interface, which is configured to reproduce the image content in response to a reproducing action at the current geographic location; a virtual object interactive interface, which is configured to, in response to that the image content contains a target object associated with the current geographic location, superimpose and display a virtual object associated with the target object in the reproduced image content for the interactive operation.

By way of triggering an interactive operation of a virtual object according to the current location of a mobile terminal and a reproduced image, the present invention provides a broader and more flexible application scenario and a more flexible matching condition for the virtual object, and is particularly suitable for various promotion activities related to a specific location.

### BRIEF DESCRIPTION OF DRAWINGS

The above and other objects, features and advantages of the present disclosure will become clearer by way of describing in detail exemplary embodiments of the present invention with reference to the accompanying drawings, in which similar reference numerals generally denote the same part of element in the exemplary embodiments of the present invention.

FIG. 1 shows an example of triggering the display and interaction of a virtual object in the prior art.

FIG. 2 is a schematic view of one or more embodiments of the present invention.

FIG. 3 is a flow chart of a server-side method for triggering a virtual object operation according to one embodiment of the present invention.

FIG. 4 is a flow chart of a method for triggering a virtual object operation of a mobile terminal according to one embodiment of the present invention.

FIG. 5 is a flow chart of a method for triggering a virtual object operation of a mobile terminal according to another embodiment of the present invention.

FIG. 6 is a schematic diagram of a virtual object operation triggering apparatus on a mobile terminal according to one embodiment of the present invention.

FIG. 7 is a schematic diagram of a virtual object operation triggering apparatus on a mobile terminal according to another embodiment of the present invention.

FIG. 8 is a flow chart of an interaction method of a mobile terminal according to one embodiment of the present invention.

FIG. 9 is a mobile terminal apparatus according to one embodiment of the present invention.

### DESCRIPTION OF EMBODIMENTS

Certain preferred embodiments of the present invention will be described in more detail with reference to the accompanying drawings. Although the drawings illustrate the preferred embodiments of the present disclosure, it should be understood that the present invention may be implemented in various forms and should not be limited to the embodiments set forth herein. Rather, these embodiments are provided so that this disclosure will be thorough and complete, and will fully convey the scope of the present invention to a person of ordinary skill in the art.

With the rapid development in information technology, people use different types of terminals to operate all kinds of virtual objects. Unlike a real object in a real scene shot through, for example, a camera lens, a “virtual object” is synthesized or displayed by a computing device. A virtual object can be a virtualized model (for example, a virtual heart model 102 as shown in FIG. 1) that mimics a real-life object, an abstract object (for example, a text or an image), or a completely virtualized object (for example, the Pokémon in the game Pokémon GO). A virtual object can be displayed in a virtual scene. For example, an avatar displayed in various role-playing games played on terminal devices, it may also be combined with the augmented reality (AR) technology, for example, various virtual objects which are superimposed on real scenes. Users can engage in various types of interaction with virtual objects, thereby having an experience that cannot be experienced or is hardly to be experienced in the real world. Similarly, in reference to FIG. 1, FIG. 1 shows a beating heart model displayed on a terminal device (for example, a smartphone). A user can feel the beat frequency of the heart through a hand-held device, and select to view various portions of the heart model (such as different blood vessels or atriums/ventricles) by clicking on the selectable items provided in the lower right corner of the screen. While watching a beating heart is one of the experiences that an ordinary terminal user typically does not have.

Although the operation and interaction with virtual objects broaden the cognitive boundaries of users, considering the limitations of the current technology, there are still many limitations on the interaction between users and virtual objects. First, the trigger conditions are often strictly restricted. For example, the display of the virtual heart in FIG. 1 requires scanning the corresponding two-dimensional images of a heart in order to trigger displaying the virtual heart. That is, when scanning other two-dimensional heart images, the display of a virtual heart cannot be triggered. Second, the virtual object itself and the interactive operation thereof are very simple. For example, a map application may display various embedded virtual objects, but such displayed embedded virtual objects are usually limited in kind and simple in function. In one existing technology, the corresponding shop logos are embedded and displayed at the corresponding locations of each shop in a map scene, so as to have an effect of emphasis.

In view of the foregoing, the present invention proposes a completely new interactive triggering solution. The solution is as follows: first pre-screens according to the current geographic location information of a mobile terminal the candidate objects associated with the current location (for example, a landmark of the current location), and then matches the candidate object with the reproduced targets on the mobile terminal, so as to provide the interactive operation (for example, an interactive service) with the virtual object associated with the reproduced target. In this way, terminal users can be provided with a variety of services based on their geographic locations, thereby enhancing user's engagement, live feeling and enjoyment.

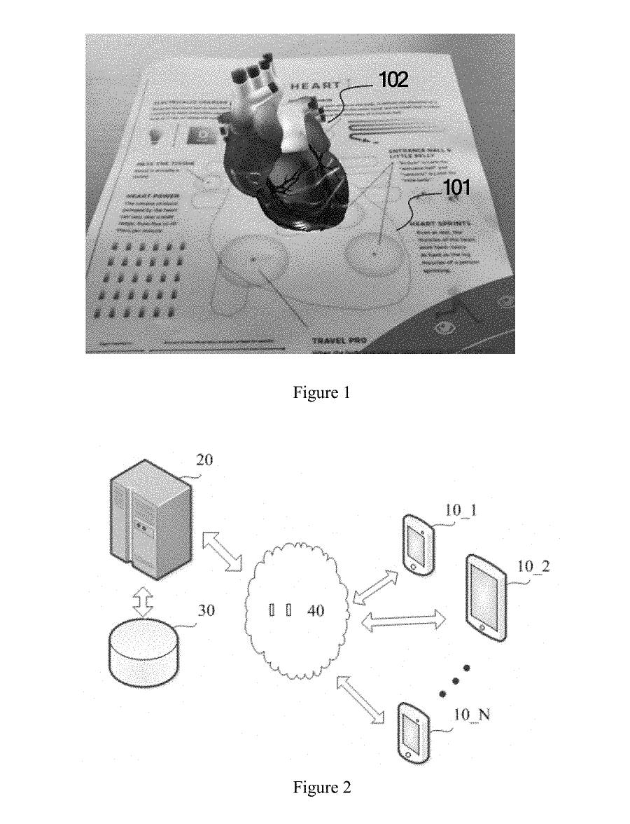

The virtual object interaction triggering solution provided by one or more embodiments of the present invention may be applied to the environment as shown in FIG. 2. FIG. 2 is a schematic view of an environment 200 for implementing one or more embodiments of the present invention. In one embodiment, the mobile terminal 10 in the environment 200 may send and receive information with the server 20 via the network 40. The server 20 may obtain the content required by the mobile terminal 10 by accessing the database 30. Different mobile terminals (for example, between 10_1 and 10_2 or 10_N) may also communicate with each other via the network 40. Network 40 can be a broadly defined network for information delivery, and may include one or more communication networks, such as wireless communication networks, the Internet, private area networks, local area networks, metropolitan area networks, wide area networks, cellular data networks, and so on. In one embodiment, the network 40 may also include a satellite network, thereby transmitting the GPS signal of the mobile terminal 10 to the server 20. It should be noted that if an add-on module is added to or removed from element 200 in the drawings, the underlying concept of the embodiments of the present invention will not be altered. Although the bidirectional arrows between the database 30 and the server 20 are shown in the drawings for the sake of convenience of illustration, a person of ordinary skill in the art can understand that the transmission and reception of the data mentioned above may also be carried out through the network 40.

The mobile terminal 10 can be any suitable portable electronic device that may be used for network access, including, but not limited to, a smartphone, a tablet, and other portable clients. Server 20 is any server that can be accessed through the network to provide the information needed for an interactive service. Although a plurality of mobile terminals 10-1 . . . N and a single server 20 and a database 30 are shown in the figure, and one or a part of the mobile terminals may be selected for description (for example, the mobile terminal 10-1) in the subsequent description, a person of ordinary skill in the art should understand that the above 1 . . . N mobile terminals are intended to represent multiple mobile terminals existing in a real network. The single server 20 and the database 30 are shown to indicate that the technical solution of the present invention relates to an operation with a server and a database. The specific numbered mobile terminals as well as single server and databases are described in detail at least for convenience of illustration and do not imply limitations on the type or location of mobile terminals and servers.

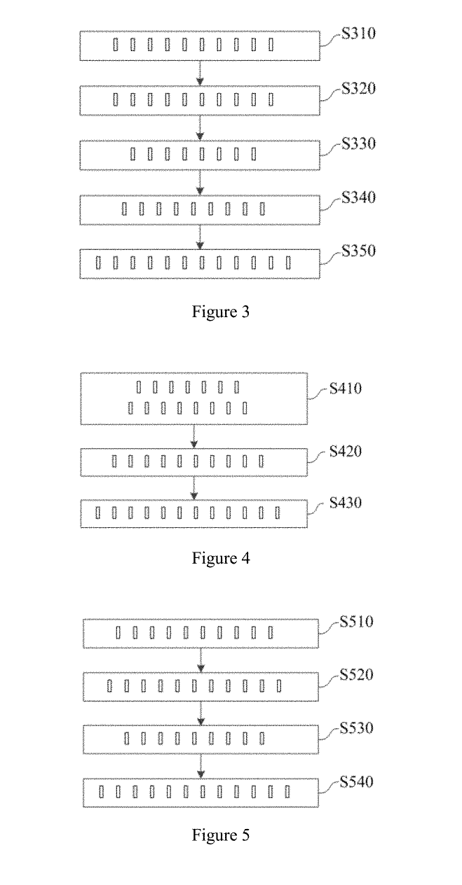

FIG. 3 is a flow chart of a server-side virtual object operation triggering method 300 according to one embodiment of the present invention. The method may be made for the mobile terminal via the network 40 (including a satellite network) by the server shown in FIG. 2.

At step 310, the server obtains the current geographic location information of the mobile terminal. The location information of the mobile terminal may be determined by a base station, a satellite or a data communication network, and the corresponding positioning information (for example, GPS information) is then transmitted to the server.

At step 320, the server queries the database for candidate object information associated with the current geographic location information. The database herein may be, for example, the database 30 shown in FIG. 2. The database can be a centralized or distributed database, wired or wirelessly connected to the server, or it can be part of a server.

Candidate object information (also referred to as “identifiable object” information) corresponding to a geographic location is stored in the database through association. In one embodiment, different levels of candidate object information may be stored based on the accuracy and range of respective geographic location information. First, an exact geographic location and its associated small number of identifiable objects can be stored through association. Second, a relatively large geographic range and its associated many identifiable objects can be stored through association. Finally, a very large geographic range and its associated large number of identifiable objects can be stored through association. For example, for the scenario of a shopping street (for example, the Nanjing Road in Shanghai), a small number of identifiable objects (for example, a store logo) associated with a particular brand showcase (a geographic location) in a particular shopping store may be saved in association with that particular brand showcase. In another example, the identifiable objects (for example, products of different brand names participating a promotion activity) associated with a larger range of geographic location on a particular floor in a particular shopping store (for example, the department of women's dress on the second floor) can be saved in association with a number of different brand name showcases of women's dresses on that floor. Next, it may be in an even larger range, for example, a particular store, or even the entire shopping street, and the identifiable objects associated with them can be saved in association with these large geographic location ranges. The number of association storage levels and how the different levels are determined can be flexibly selected according to the actual situation.

In one embodiment, the candidate object information associated with the current geographic location information may include the candidate object information associated with a landmark object corresponding to the current geographic location information. Herein, the term “landmark object” may refer to an iconic location or place where the current geographic location is located. For example, if the current geographic location shows that the mobile terminal is located at the bronze pavilion on the first floor of the Shanghai Museum, the “landmark” can be the Shanghai Museum or the People's Square where the Shanghai Museum is located, rather than the smaller location range of bronze pavilion or the larger location range of Huangpu District. In other embodiments of the present invention, the candidate object information associated with the current geographic location information may be candidate object information associated with different ranges of geographic locations of the current geographic location information. For example, in a similar case, when the mobile terminal is located in the bronze pavilion on the first floor of the Shanghai Museum, a user is able to inquire regarding a few exhibits at exactly the location, all identifiable objects in the bronze pavilion, or all identifiable objects on the first floor of the museum, and so on.

The server obtains the image information reproduced on the mobile terminal in step 330. The reproduced image may be a real-time image taken by the mobile terminal, a real time image read by the mobile terminal, or an image in the video that is being played on the mobile terminal. The reproduced image can be archived through awakening a camera module through a scanning icon or a photo shooting icon in an application (App). For example, a user may awaken the camera module in a mobile terminal to take a picture in real time by touching or clicking a scanning icon or a photo shooting icon of a browser application, a WeChat or headline application, a video application, a shopping application, a reading application, and so on, or identifying previous pictures or videos in a photo album. In addition, an application program may also superimpose the triggering solution of the present invention on a start screen or an activity screen. For example, before entering the home page of an application, the user can enter the mode of image shooting, or previous image/video reading mode through a start page, and subsequently trigger the display and interaction of a virtual object.

In step 340, a target object that matches the candidate object information is identified from the reproduced image information, and then in step 350, an interactive operation of the predetermined virtual object on the mobile terminal that is associated with the target object is triggered. In step 350, the virtual object in the triggered display is preferably directly superimposed on the image/video captured or read in real time by the mobile terminal, instead of jumping to a completely virtual environment. In this way, a user is able to interact with the virtual object in an AR environment (in the case where the virtual object is superimposed on the content of an image taken in real time) or in a virtual scene (in the case where the virtual object is superimposed on the video/image read in real time), thereby enhancing the user's interactive engagement and freshness.

In one embodiment, if the image is a real-time image being taken by the mobile terminal, an augmented reality operation of superimposing a predetermined virtual object onto a real time captured by the mobile terminal may be triggered by identifying the object in the currently shooting image.

In one embodiment, the steps of obtaining the geographic location information and the reproduced image information can be performed in any order or simultaneously prior to matching the target object. In a broad sense, as long as the geographic location information and the reproduced image information can be obtained before the target object is identified and matched; there is no need to emphasize the order of these steps. However, in a more specific scenario, distinguishing the order of the steps of obtaining the geographic location information and the reproduced image information may be helpful to further improve the efficiency of the triggering solution of the present invention. In one embodiment, for opening a specific application and taking a real-time photo at the current location, it is preferable to upload the current geographic location information when the application is being turned on, thereby triggering in advance queries on identifiable objects. The geographic location information and the captured image information may also be acquired simultaneously (for example, the current captured image having the corresponding geographic location information) and searched together on the server side. In one embodiment, if the server acquires an image or a video that is previously captured and currently being reproduced by the mobile terminal, the server may first determine the target object and then determine the location of it, or may not read the current location information of the mobile terminal, rather read the geographic location information of the previous image shooting, thereby matching the reproduced image with the identifiable object associated with the geographic location at which it was shot, so as to trigger the corresponding interactive operation.

FIG. 4 is a flow chart of a virtual object operation triggering method 400 of a mobile terminal according to one embodiment of the present invention. The method may be implemented by any mobile terminal 10 shown in FIG. 2 through a network 40 (including a satellite network) and based on a service provided by a server.

In step 410, the mobile terminal transmits the reproduced image information and the current geographic location information to the server. Corresponding to the server-side operation, the foregoing steps of sending the above information by the mobile terminal may be performed at the same time, or in a certain order. Preferably, the server side is allowed to query the candidate object information (or identifiable object) associated with the current geographic location information first, and then identify the target object according to the reproduced image information.

In step 420, the mobile terminal receives the target object matching information returned by the server regarding identifying the target object matching the candidate object from the reproduced image information, and then in step 430, according to the target object matching information, triggers an operation of a pre-determined virtual object associated with the target object.

Corresponding to the description in FIG. 3, in the embodiment shown in FIG. 4, the database may also store different levels of candidate target information according to the accuracy and range of the geographic location information, and the server can select, according to the specific application, to query the candidate object information associated with different geographic ranges (for example, landmark objects) corresponding to the current geographic location.

In an embodiment, different from the operations shown in FIGS. 3 and 4 in which the object matching operation is carried out on the server side, the object matching operation may also be performed on the mobile terminal. FIG. 5 is a flow chart of another virtual object operation triggering method 500 of a mobile terminal according to one embodiment of the present invention. The method may likewise be implemented by any mobile terminal 10 shown in FIG. 2 through a network 40 (including a satellite network) and based on a service provided by a server.

In step 510, the server side sends the current geographic location information to a server, and in step 520 receives the candidate object information associated with the current geographic location information, which is queried by the server in the database. Subsequently, in step 530, a target object matching the candidate object information can be identified from the reproduced image by the mobile terminal, and in step 540, an interactive operation of the predetermined virtual object associated with the target object is triggered. Corresponding to the server side, different from the step S330 of obtaining the reproduction image and the step S340 of performing the matching operation as shown in FIG. 3, the server can directly send the queried associated candidate object information to the mobile terminal, and then the mobile terminal completes the target object matching process and triggering the interaction operation. The embodiment shown in FIG. 5 is particularly suitable for such situations where the identifiable objects associated with the current geographic location are very limited (for example, the lower associated level that is only associated with the exact geographic location) and/or the information of the identifiable objects is relatively simple. While for application scenarios having a large number of associated candidate objects, the embodiments shown in FIGS. 3 and 4 are still preferred, in which the target matching is completed on the server side.

In addition, the interactive operation information of the predetermined virtual object may be pre-stored in the mobile terminal or may be delivered by the server in a real-time manner, which may be selected flexibly according to, for example, the size of interactive operation information, the update dependency of interactive operation information, and so on. In one embodiment, the predetermined virtual object itself may be pre-stored (for example, when the number of virtual object is relatively large) by the server, and the different interactive information for different target objects may be delivered by the server in a real-time manner, thereby achieving both timeliness and visibility.

A general flow of a method for triggering an interactive operation with a virtual object according to the present invention has been described above in reference with FIGS. 3 to 5. The objects and operations involved in the solution of the present invention will be further described with reference to the following examples.

In one embodiment, the candidate object associated with the current geographic location and the matching target object may be at least one of the following objects: a product, a business logo, another specific graphic shape. Herein, the product may be various types of items which are currently on sale and can be identified by the mobile terminal. The size of the product may be varied, for example, various types of earrings in a jewelry store, various types of clothing on the clothing store shelves, various vehicle models in a 4S shop, etc., as long as the mobile terminal can shoot images of them and can identify them. A business logo can be various types of two-dimensional or three-dimensional graphics used to indicate a brand name, for example, the logo of “Starbucks” can be used as an identifiable object, and the logo of a double-tailed mermaid can also be used as an identifiable object. In addition, the identifiable objects may also be in other specific graphic shapes that are sufficiently distinguishable from other common items. For example, the Oriental Pearl TV Tower and Guangzhou Tower are important landmarks in Shanghai and Guangzhou, respectively, and their specific shapes of dual balls and “slim waist” can be easily identified. Therefore, the silhouette images of the Oriental Pearl Tower and the Canton Tower can also be stored as the identifiable objects; and preferably stored in association with their respective best shooting locations. For example, if a user scans the image of the Oriental Pearl Tower across the river on the Bund, it can trigger the matching interactive services, such as superimposing and displaying virtual objects within the shooting scene, and by way of the interaction with the virtual objects, a user may win shopping coupons or coupons for exchange of a mini model of the Oriental Pearl Tower.

In one embodiment, an interactive operation of a predetermined virtual object associated with a target object may provide a service associated with the target object. The association between the interactive operation and the target object may be reflected in that the action performed by the virtual object is associated with the target object, or in that the result of the interaction operation is associated with the target object. For example, in the case of accurately matching the current geographic location, a user may scan a commercial identity (for example, logo) of Starbucks, and accordingly can trigger an ordering function in a virtual scene on the mobile terminal. In this way, the user is able to, for example when waiting in a line to make an order, trigger a virtual shop attendant by way of shooting a real-time image of a Starbucks related logo or reading a stored related image or video. The virtual attendant can be superimposed on a real-time video or a read image/video, and the user is able to make an order and corresponding payment by way of the interaction with the virtual attendant. The order information is then sent to the specific Starbucks where the user is currently located, after receiving the order information, an attendant in the store can prepare the ordered product (for example, a cup of coffee). In another example, for a promotion activity covering a mall or neighborhood, the identification of various identifiable objects can trigger superimposing a virtual red envelope onto a real-time video or a read image/video. However, the result of a user catching a virtual red envelope can be a coupon or other types of reward for the identified target object.

As described above, the interactive operation performed between the user of a mobile terminal and the virtual object may be a commercial activity associated with the target object. The above interaction can also be a game or social activity. For example, a user may scan a particular object in a game vendor's offline promotion activity, thereby triggering the virtual object superimposed on a real object scene. The user can interact with the virtual object in such an AR scenario, for example, playing a small game to win a reward, so as to finish a hidden story of the online game on the mobile terminal or obtain a hidden treasure, etc. Various social networking sites can also conduct offline social activities in combination with the interactions with certain virtual objects at specific locations, and users can gain their community points or make new friends in the community by way of scanning specific identifiable objects within specific geographic ranges and interacting with the superimposed and played virtual objects. In addition, games and/or social activities and/or business activities can also be integrated together in a particular scene. For example, an amusement park may set an on-site treasure hunting game, and the user can complete each level of an augmented reality treasure hunting by identifying a particular object at a particular location (for example, a user may scan a character model at a particular location, thereby triggering an interaction with the virtual object of the scanned character in the AR scene, so as to play various interactive games). Moreover, users may also get different types of actual incentives, such as fast pass or free rewards according to their game play scores or levels.

Commercial activities, games, and/or social activities associated with the target object may include at least one of the following activities: obtaining a preferential voucher or coupon associated with the target object, initiating an online transaction associated with the target object, entering an online community associated with the target object, or obtaining a reward from an activity of an online community associated with the target audience, or the like. For example, a user may scan or read a specific product image in store, identify a specific product, trigger a virtual cashier superimposed on a live video or a read image/video, complete an online payment, and exit the store with the paid products.

In one embodiment, the virtual object may include a virtual red envelope. Specifically, for a year-end red envelope catching scene, the business identifier associated with each geographic location may be stored in a database, for example, the brand logos, and a user can take a photo of a business identifier or read a business identifier in a saved image at a specific location to achieve identification of the target object from one of the reproduced images having the candidate business identifier, and thereby identifying and triggering a corresponding operation with red envelope.

In one embodiment, the predetermined virtual object in the present invention may preferably is not an enhanced display of the identified target object itself. In other words, the identified target object is not the virtual object to be displayed, or at least not the main virtual object to be displayed. For example, when a user is scanning a Starbucks logo, it can trigger displaying the specific coupons or red envelopes for that particular Starbucks store, or trigger an interactive game and then reward the user the coupons as a reward of an interactive action. In another example, a user may scan the logo of UNIQLO or certain clothes in the store, and trigger the display of the user's own virtual image. The user can perform a virtual fitting check by scanning different clothes. In the first example, the virtual object (coupon or red envelope) is not the identified target object (the Starbucks logo) itself. In the latter example, although the virtual object includes a target object (for example, clothing) that has been identified through scanned; the main part of the virtual object is the user's own virtual image, rather than the target object itself. Preferably, the reproduced image is a miniature environment that contains a single identifiable object, for example, a user can scan a brand or a product in front of the user, rather than the entire street view, thereby facilitating the matching and identification of a particular identifiable object.

The aforementioned triggering method according to the present invention may also be combined with a subsequent sharing operation. Therefore, in one embodiment, a sharing method may include: generating content for sharing and at least one sharing link access, according to the interaction result of the interaction operation triggered previously; and then based on a user's selection on the sharing link access, posting the content for sharing to a corresponding location indicated in the user's selection on the access. The generated content for sharing may be a screenshot or an animation of an augmented reality operation in which the predetermined virtual object is superimposed on a real-time image captured by the mobile terminal, or a content that incorporated with certain user features (for example, a user icon), or may be other content related to the current geographic location or the interaction result with the virtual object. The sharing link access may include those common sharing destinations, for example, links or accesses for making a post to the WeChat friends, circle of friends, Sina Weibo, QQ friends, QQ space, and the like. In addition, it is also possible to create a specific link to access the shared content or make a duplicated of the link if necessary. Moreover, the content for sharing may vary depending on the specific sharing access selected by a user. For example, in one scenario, a user at the Starbucks in the People's Park in Shanghai triggers an interactive operation to catch a virtual red envelope and then receives a Starbucks coupon for that particular store; next, the user may share the corresponding content to the user's circle of friends or Weibo. The shared content may be, for example, an image taken at the current location which is superimposed with the coupon object and/or user identity content (for example, a virtual character with the user's avatar has caught a coupon), or an existing image of the current store or landmark superimposed with an interactive result and/or user identity content, and so on.

The virtual object interaction operation triggering method according to the present invention and various examples and derivative solutions thereof are described above. The triggering device and the interaction and display system will be described further below.

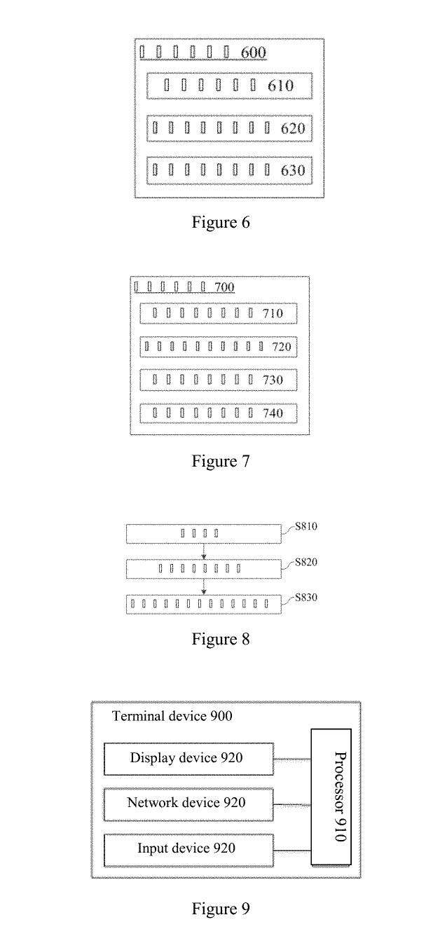

FIG. 6 is a schematic diagram of a virtual object operation triggering apparatus on a mobile terminal according to one embodiment of the present invention. Corresponding to the method shown in FIG. 4, the interactive operation triggering apparatus 600 shown in FIG. 6 may include an information transmitting unit 610, a matching information obtaining unit 620, and an interactive operation triggering unit 630. The information transmitting unit 610 is able to transmit the reproduced image information and the current geographic location information to a server. The matching information obtaining unit 620 is able to receive the target object matching information returned by the server for identifying the target object that matches the candidate object from the reproduction image information. The interactive operation triggering unit 630 may then trigger an interactive operation of a predetermined virtual object corresponding to the target object according to the target object matching information.

In one embodiment, the identification and matching of the target object can also be implemented on the side of mobile terminal. FIG. 7 is a schematic diagram of a virtual object operation triggering apparatus on a mobile terminal according to another embodiment of the present invention. Corresponding to the method shown in FIG. 5, the apparatus for interaction operation 700 in FIG. 7 may include a geographic information transmitting unit 710, a candidate object information receiving unit 720, a target object identifying unit 730, and an interaction operation triggering unit 740. The geographic information transmitting unit 710 is able to transmit the current geographic location information to a server. The candidate object information receiving unit 720 is able to receive the candidate object information that is queried by the server in a database and associated with the current geographic location information. The target object identifying unit 730 is able to identify a target object that matches the candidate object information from the reproduced image. The interactive operation triggering unit 740 is able to accordingly trigger an interactive operation of the predetermined virtual object associated with the target object on a mobile terminal.

In one embodiment, the mobile terminal may also implement an interactive method with a virtual object. FIG. 8 shows a flow chart of an interaction method on a mobile terminal according to an embodiment of the present invention. From the perspective of displaying on the mobile terminal, in step S810, the mobile terminal reproduces an image at the current geographic location, in step S820, identifies a target object associated with the current geographic location, and in step S830, display a virtual object associated with the target object for a further interactive operation. The aforementioned identification of the target object is unseen while the user viewing the mobile terminal display, and may also include the process of screening the candidate objects and identifying and matching the target object performed on the mobile terminal or the background server.

In another embodiment, the present invention also discloses a graphical user interface system on a portable electronic device having a touch screen display, which includes: an image display interface for reproducing the image content in response to a reproducing action at the current geographic location, a virtual object interactive interface for, in response to that the image content contains a target object associated with the current geographic location, superimposing and displaying the virtual object associated with the target object onto the reproduced image content for an interactive operation.

In an embodiment, the present invention also discloses a mobile terminal device according to an embodiment of the present invention. As shown in FIG. 9, the mobile terminal device 900 may have a structure corresponding to the mobile terminal shown in FIG. 2. The mobile terminal device 800 may include a processor 910, a display device 920, a networking device 930, and an input device 940.

The input device 940 is configured to receive a user input, and the display device 920 is configured to display output to a user. In a preferred embodiment, the functions of the input device and the display device may be integrated to the touch screen. The networking device 930 is configured to send and receive networking information. The processor 910 connected to the display device 920, the networking device 930, and the input device 940 may be configured to send the current geographic location information acquired via the networking device 930 to a server via the networking device 930, and reproduce the image on the display device 920. In addition, it may also function to determine, according to specific situations, the process of matching and identifying of the reproduced image with associated identifiable object are carried out on the local device or the backend server, and subsequently trigger displaying the virtual object on the display device 920, thereby enabling a user to interact with the virtual object through the input device 940. In addition, although not explicitly shown, the device may further include a memory (for caching and storing various information) connected to the processor 910.

It should be understood that the triggering method described above with reference to FIGS. 3-5 and the preferred embodiments thereof may also be implemented by the corresponding apparatuses and client devices shown in FIGS. 6-8 and FIG. 9, and details are not described herein again.

Again in reference to FIG. 2, FIG. 2 may be viewed as including an interactive system that can be used to implement the inventive triggering solution of the present invention. In one embodiment, a virtual object interaction system includes a server and a mobile terminal. The mobile terminal reproduces the image and sends the current geographic location information to the server. The server queries the database for candidate object information corresponding to the current geographic location information, where the server or the mobile terminal identifies a target object that matches the candidate object from the reproduced image, and triggers displaying a predetermined virtual object on the mobile terminal, the predetermined virtual object interacts with the user of the mobile terminal, and the interaction operation can be associated with the target object.

The trigger solution for virtual object operation according to the present invention has been described in detail above with reference to the accompanying drawings. The present invention first locates the current location of a terminal through a network or a satellite, and then queries a database for identifiable objects existing at the current location. The user can record the object information by way of camera preview, taking photo or video, and correspondingly, the terminal or the background server can identify objects from the data collected by the user through the camera or reading stored content. If the identified data matches the foreground or background predefined image, the identification is successful. The successful identification can then trigger a corresponding predefined behavior, such as displaying an animation on the terminal, providing information for triggering an off-line transaction, and so on. Therefore, through the identifiable object information saved in association with corresponding geographic location information, the present invention is able to further optimize real object identification and application scenarios triggered by virtual object, so as to improve a user's live feeling, in particular, the present invention is especially applicable to various types of commercial applications, such as virtual red envelope, on site purchase, and so on.

In addition, the method according to the present invention can also be implemented as a computer program containing computer program code instructions for carrying out the above-described steps as defined in the above method of the present invention. Alternatively, the method according to the invention may also be implemented as a computer program product including a computer-readable medium, where the computer-readable medium is stored with a computer program for implementing the functions mentioned above defined in the method of the invention program described above. A person of ordinary skill in the art will also appreciate that the various illustrative logical blocks, modules, circuits, and algorithm steps described in connection with the disclosure herein may be implemented as electronic hardware, computer software, or a combination of both.

The flow charts and block diagrams in the figures illustrate the architecture, functionality, and operation of possible implementations of the systems and methods in accordance with various embodiments of the present invention. In this regard, each block of the flow charts or block diagrams may represent a module, a section of a program, or a portion of a code that includes one or more portions of a program for implementing the executable instructions for the specified logic functions. It should also be noted that in some alternative implementations, the functions labeled in the blocks may occur out of the order indicated in the drawings. For example, two consecutive blocks may in fact be executed substantially in parallel, and sometimes they may be executed in a reverse order, depending on the specific function involved. It is also to be noted that each block of the block diagram and/or flow chart, and combinations of blocks in the block diagrams and/or flow charts can be implemented by special purpose hardware-based systems that perform the specified functions or operations, or may be implemented using a combination of dedicated hardware and computer instructions.

A few different embodiments of the present invention are described above. The foregoing description is exemplary, not exhaustive, and is not intended to be limited to the disclosed embodiments. Many modifications and variations will be apparent to a person of ordinary skill in the art without departing from the scope and spirit of the illustrated embodiments. The terminology used herein is chosen to best explain the principles of the embodiments, the practical application, or improvements in technology available in the market, or to enable others of ordinary skill in the art to understand the embodiments disclosed herein.

1. A method for triggering an interactive operation with a virtual object, comprising:
obtaining a current geographic location information of a mobile terminal;
querying, in a database, candidate object information associated with the current geographic location information;
obtaining reproduced image information on the mobile terminal;
identifying a target object that matches the candidate object information from the reproduced image information; and
triggering an interactive operation with a predetermined virtual object associated with the target object on the mobile terminal.

2. A method for triggering an interactive operation with a virtual object on a mobile terminal, comprising:
sending current geographic location information to a server;
receiving candidate object information associated with the current geographic location information queried by the server from a database;
identifying a target object that matches the candidate object information from reproduced image information; and
triggering an interactive operation with a predetermined virtual object associated with the target object.

3. A method for triggering an interactive operation with a virtual object on a mobile terminal, comprising:
sending reproduced image information and current geographic location information to a server;
receiving target object matching information of a target object identified from the reproduced image information returned from the server, wherein the target object matches a candidate object, and wherein candidate object information is the candidate object information queried by the server from a database and is associated with the current geographic location information; and
triggering an interactive operation with a predetermined virtual object associated with the target object according to target object matching information.

4. The method according to claim 1, wherein, the candidate object information associated with the current geographic location information comprises candidate object information associated with a landmark object corresponding to the current geographic location information.

5. The method according to claim 1, wherein, the candidate object associated with the current geographic location information, and the target object matching the candidate object are at least one of the following objects:
a product;
a business logo; or
another specific graphic shape.

6. The method according to claim 1, wherein, the interactive operation with the predetermined virtual object associated with the target object provides a service associated with the target object.

7. The method according to claim 1, wherein, the predetermined virtual object is not directed to the identified target object itself.

8. The method according to claim 1, wherein, the virtual object comprises a virtual red envelope.

9. The method according to claim 1, wherein, the interactive operation with the predetermined virtual object is an augmented reality (AR) operation of superimposing the predetermined virtual object onto a real-time image captured by the mobile terminal.

10. The method according to claim 1, wherein, step of obtaining the current geographic location information and the step of obtaining the reproduced image information are carried out in any order or simultaneously prior to the step of matching the target object.

11. The method according to claim 2, wherein, the candidate object information associated with the current geographic location information comprises candidate object information associated with a landmark object corresponding to the current geographic location information.

12. The method according to claim 2, wherein, the candidate object associated with the current geographic location information, and the target object matching the candidate object are at least one of the following objects:
a product;
a business logo; or
another specific graphic shape.

13. The method according to claim 2, wherein, the interactive operation with the predetermined virtual object associated with the target object provides a service associated with the target object

14. The method according to claim 2, wherein, the predetermined virtual object is not directed to the identified target object itself.

15. The method according to claim 2, wherein, the virtual object comprises a virtual red envelope.

16. The method according to claim 2, wherein, the interactive operation with the predetermined virtual object is an augmented reality (AR) operation of superimposing the predetermined virtual object onto a real-time image captured by the mobile terminal.

17. The method according to claim 3, wherein, the candidate object information associated with the current geographic location information comprises candidate object information associated with a landmark object corresponding to the current geographic location information.

18. The method according to claim 3, wherein, the candidate object associated with the current geographic location information, and the target object matching the candidate object are at least one of the following objects:
a product;
a business logo; or
another specific graphic shape.

19. The method according to claim 3, wherein, the interactive operation with the predetermined virtual object associated with the target object provides a service associated with the target object.

20. The method according to claim 3, wherein, the predetermined virtual object is not directed to the identified target object itself.
